(19) United States
(12) Patent Application Publication
(10) Pub. No.: US 2013/0012128 A1
(43) Pub. Date: Jan. 10, 2013

(54) APPARATUS AND METHOD FOR PERFORMING HANDS-FREE FUNCTION OF PORTABLE TERMINAL

(75) Inventor: Sang-Don KIM, Gyeonggi-do (KR)

(73) Assignee: SAMSUNG ELECTRONICS CO., LTD., Gyeonggi-Do (KR)

(21) Appl. No.: 13/405,519

(22) Filed: Feb. 27, 2012

(30) Foreign Application Priority Data
Jul. 4, 2011 (KR) 10-2011-0066028

(51) Int. Cl. H04W 4/00; H04B 7/00

(52) U.S. Cl. 455/41.2; 455/569.1

(57) ABSTRACT

Disclosed is an apparatus and a method for performing a hands-free function of a portable terminal by allowing the portable terminal to perform a hands-free accessory function of a device in communication with the portable terminal through wireless communication. The apparatus includes: a hands-free function unit connected to an audio gateway function unit of a device to implement a hands-free communication mode; and an audio gateway function unit for outputting audio data received from the device and transmitting audio data input from the portable terminal to the device during the hands-free communication mode.

### CLAIM OF PRIORITY

This application claims the priority under 35 U.S.C. §119 of an application entitled “Apparatus And Method For Performing Hands-Free Function Of Portable Terminal” filed in the Korean Intellectual Property Office on Jul. 4, 2011 and assigned Serial No. 10-2011-0066028, the contents of which are hereby incorporated by reference.

### BACKGROUND OF THE INVENTION

1. Field of the Invention

The present invention relates to an apparatus and a method for performing a hands-free function of a portable terminal, and more particularly to an apparatus and a method for performing a hands-free function that allows the user to perform a hands-free accessory function of another device in communication with a portable terminal.

2. Description of the Related Art

Hands-free profile version 1.5 define the kind of connection between devices. There are many profiles defined for Bluetooth use, and HFR functions most widely used in Bluetooth devices are generally classified into an audio gateway (AG) function applied to a portable terminal and a hands-free function applied to a hands-free accessory.

The audio gateway (AG) function corresponds to a device for inputting/outputting audio data, and it includes a BT processor and a modem. The hands-free function corresponds to a device operating as a remote audio inputting/outputting mechanism of the audio gateway. That is, when a portable terminal including an audio gateway (AG) function implements a hands-free communication mode through a hands-free accessory, PCM audio data received from the hands-free accessory is generally transferred to a PCM codec of a modem through a BT processor of the portable terminal.

As tablet terminals are currently used widely, Bluetooth hands-free accessories are being increasingly utilized for realizing the VoIP or 3 G communication of the tablet terminals.

However, it is inconvenient to perform voice communication through a tablet terminal due to the size of the tablet terminal, without using a Bluetooth hands-free accessory. As a result, a user of a tablet terminal often carries a conventional portable terminal in addition to the tablet terminal in order to perform voice communication.

### SUMMARY OF THE INVENTION

Accordingly, an aspect of the present invention is to solve the above-mentioned problems occurring in the prior art and provides additional advantages, by providing an apparatus and a method for performing a hands-free function of a portable terminal by allowing the portable terminal to perform a hands-free accessory function of another device connected to the portable terminal through wireless communication.

Another aspect of the present invention provides an apparatus and a method for performing a hands-free function of a portable terminal, in which audio data received by a first device can be transmitted to a second device through the portable terminal capable of performing a hands-free accessory function when the portable terminal is connected to at least two devices including the first device and the second device in a hands-free communication mode.

In accordance with an aspect of the present invention, an apparatus for performing a hands-free function of a portable terminal includes: a hands-free function unit coupled to an audio gateway function unit of another device to implement a hands-free communication mode; and an audio gateway function unit for outputting audio data received from another device and transmitting audio data input from the portable terminal to another device in the hands-free communication mode.

In accordance with another embodiment of the present invention, an apparatus for performing a hands-free function of a portable terminal includes: a hands-free function unit for implementing a hands-free communication mode in a state in which the hands-free function unit is coupled with an audio gateway function unit of a first device; and an audio gateway function unit for implementing the hands-free communication mode in a state in which the audio gateway function unit is communication with the hands-free function unit of the second device in the hands-free communication mode with the first device, wherein the audio gateway function unit allows bypassing of audio data received from the first device and transmits the audio data received from the first device to the second device, and allows bypassing of audio data received from the second device and transmits the audio data received from the second device to the first device.

In accordance with still another embodiment of the present invention, a method of performing a hands-free function of a portable terminal includes: switching a mode of the portable terminal into a hands-free communication mode by a hands-free function unit of the portable terminal in communication with an audio gateway function unit of another device; when audio data is received from another device, outputting the received audio data in the hands-free communication mode; and when audio data is input through the portable terminal, transmitting the input audio data to another device in the hands-free communication mode.

In accordance with yet another embodiment of the present invention, a method of performing a hands-free function of a portable terminal, includes: implementing a hands-free communication mode by a hands-free function unit of the portable terminal in communication with an audio gateway function unit of a first device, and implementing the hands-free communication mode by an audio gateway function unit of the portable terminal in communication with a hands-free function unit of a second device; when audio data is received from the first device in the hands-free communication mode, causing bypassing of the audio data received from the first device and transmitting the audio data received from the first device to the second device; and when audio data is received from the second device in the hands-free communication mode, causing bypassing of the audio data received from the second device and transmitting the audio data received from the second device to the first device.

### BRIEF DESCRIPTION OF THE DRAWINGS

The above and other aspects, features and advantages of the present invention will be more apparent from the following detailed description taken in conjunction with the accompanying drawings, in which:

FIG. 1 is a block diagram illustrating an operation of a portable terminal including a hands-free function performing device that enables a hands-free communication mode with another device; according to a first embodiment of the present invention; and

FIG. 2 is a block diagram illustrating an operation of a portable terminal including a hands-free function performing device that enables a hands-free communication mode with two other devices according to a second embodiment of the present invention.

### DETAILED DESCRIPTION

Hereinafter, exemplary embodiments according to the present invention will be described with reference to the accompanying drawings. It should be note that the same reference numerals denote the same or like elements in the drawings.

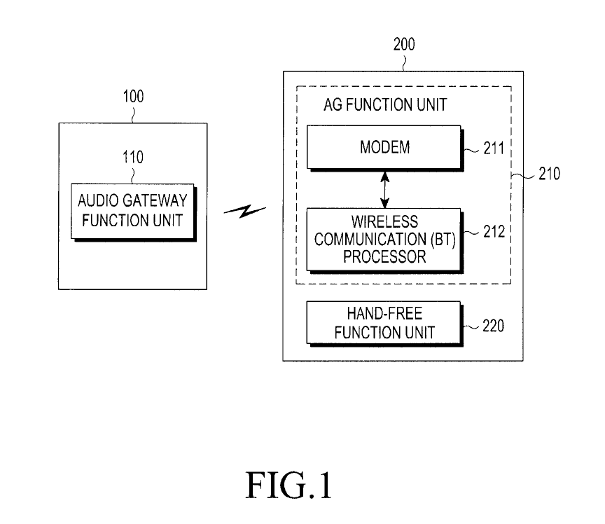

FIG. 1 is a block diagram depicting an operation of a portable terminal including a hands-free function performing device according to a first embodiment of the present invention that allows the user to implement a hands-free communication mode with another device. Although the following description with reference to FIG. 1 is based on an example in which another device is a tablet terminal, the teachings of the present invention may be also applied to other devices including only an audio gateway function unit.

Referring to FIG. 1, a portable terminal 200 according to the first embodiment of the present invention employs a hands-free profile including an audio gateway function unit 210 and a hands-free function unit 220.

When the portable terminal 200 is in communication with a tablet terminal 100 through wireless communication, the hands-free function unit 220 allows the portable terminal 200 to perform a hands-free accessory function for the tablet terminal 100. That is, the hands-free function unit 220 is connected to an audio gateway function unit 110 of the tablet terminal 100, and implements a hands-free communication mode to allow the portable terminal 200 to perform the hands-free accessory function for the tablet terminal 100. The hands-free function unit 220 establishes and implements the hands-free communication mode with the tablet terminal 100 through Bluetooth wireless communication.

The audio gateway function unit 210 includes a wireless communication (specifically, Bluetooth (BT) wireless communication) processor 212 and a modem 211. The wireless communication (BT) processor 212 transmits PCM audio data received from the tablet terminal 100 to the modem 211 through wireless communication (specifically, Bluetooth wireless communication) during the hands-free communication mode. The modem 211 includes a PCM audio data codec. The modem 211 processes PCM audio data received from the wireless communication (BT) processor 212 and outputs the processed PCM audio data to a speaker (not shown) of the portable terminal 200, or transmits audio data received from a microphone (not shown) of the portable terminal 200 to the tablet terminal 100 through the wireless communication (BT) processor 212 during the hands-free communication mode.

In operation of the portable terminal 200 for performing a hands-free accessory function for the tablet terminal 100 including only the audio gateway function unit, the tablet terminal 100 and the portable terminal 200 are first connected to each other through a Bluetooth wireless communication protocol. Then, the portable terminal 200 is associated with the hands-free accessory function of the tablet terminal 100 through a link between the audio gateway function unit 110 of the tablet terminal 100 and the hands-free function unit 220 of the portable terminal 200.

Thus, if a call is generated in the tablet terminal during the hands-free call communication mode established between the tablet terminal 100 and the portable terminal, the generation of the call, i.e., a telephone ring, is generated via a speaker of the portable terminal. Then, in a state in which the connection for voice communication has been established between devices, the PCM audio data received from the audio gateway function unit 110 of the tablet terminal 100 is received by the modem 211 through the wireless communication (BT) processor 212 and is then output through the speaker of the portable terminal 200. Meanwhile, the audio data input to the microphone of the portable terminal 200 is transmitted to the audio gateway function unit 110 of the tablet terminal 100 through the modem 211 and the wireless communication (BT) processor 212.

By adding the hands-free function unit 220 to a portable terminal 200 as described above, the portable terminal 200 may be used as a hands-free accessory of another device, such as a tablet terminal, which includes only the audio gateway function unit.

Further, while the portable terminal 200 is performing the hands-free accessory function for the tablet terminal 100, a user may place a call connection to a specific phone number through the portable terminal 200. That is, a portable terminal used by the HF accessory function of the tablet terminal can have the function of placing the call connection.

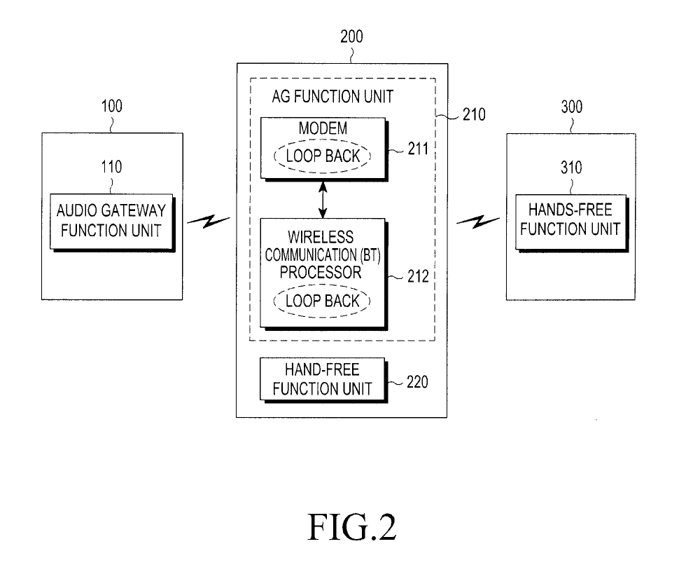

FIG. 2 is a block diagram for explaining an operation of a portable terminal having a hands-free function performing device to implement a hands-free communication mode with two other devices according to a second embodiment of the present invention. Although the following description with reference to FIG. 2 is based on an example in which a first device is a tablet terminal and a second device is a hands-free accessory, the present invention may be also applied to other devices including only either an audio gateway function unit or a hands-free function unit.

The portable terminal 200 according to the second embodiment of the present invention employs a hands-free profile including an audio gateway function unit 210 and a hands-free function unit 220. In this embodiment, the audio gateway function unit 210 performs a loop-back function for bypassing of PCM audio data.

When the portable terminal 200 has been connected to the tablet terminal 100 through wireless communication, the hands-free function unit 220 allows the portable terminal 200 to perform the hands-free accessory function for the tablet terminal 100. That is, the hands-free function unit 220 is connected to the audio gateway function unit 110 of the tablet terminal 100, and implements a hands-free communication mode to allow the portable terminal 200 to perform the hands-free accessory function of the tablet terminal 100. The hands-free function unit 220 implements the hands-free communication mode with the tablet terminal 100 through Bluetooth wireless communication.

In the hands-free communication mode with the tablet terminal 100, the audio gateway function unit 210 is also connected to a hands-free function unit 310 of a hands-free accessory 300 and implements a hands-free communication mode with the hands-free function unit 310.

The audio gateway function unit 210 includes a wireless communication (BT) processor 212 and a modem 211. The wireless communication (BT) processor 212 or the modem 211 includes a loopback function for bypassing of PCM audio data. Note that the by-pass occurs either one device of the BT processor 212 and the modem 211. Thus, if the audio gateway function unit 210 receives PCM audio data from the tablet terminal 100 connected thereto through wireless communication (BT), the loopback function of the wireless communication (BT) processor 212 or the modem 211 causes the PCM audio data received from the tablet terminal 100 to bypass the wireless communication (BT) processor 212 or the modem 211 and to be transmitted to the hands-free accessory 300.

Similarly, if the audio gateway function unit 210 receives PCM audio data from the hands-free accessory 300 connected thereto through wireless communication (BT), the loopback function of the wireless communication (BT) processor 212 or the modem 211 causes the PCM audio data received from the hands-free accessory 300 to bypass the wireless communication (BT) processor 212 or the modem 211 and to be transmitted to the tablet terminal 100.

The audio gateway function unit 210 implements the hands-free communication mode with the hands-free accessory 300 through Bluetooth wireless communication.

In operation of the portable terminal for implementing a hands-free communication mode with the tablet terminal 100 and the hands-free accessory 300, the tablet terminal 100 and the portable terminal 200 are first connected to each other through a Bluetooth wireless communication protocol. Then, the portable terminal 200 is associated with the hands-free accessory function of the tablet terminal 100 through a link between the audio gateway function unit 110 of the tablet terminal 100 and the hands-free function unit 220 of the portable terminal 200.

Similarly, in the hands-free communication mode with the tablet terminal 100, the audio gateway function unit 210 of the portable terminal 200 is connected to the hands-free function unit 310 of the hands-free accessory 300, so as to allow the hands-free communication mode between the portable terminal 200 and the hands-free accessory 300.

Thus, if a call is generated in the tablet terminal 100, the audio gateway function unit 210 of the portable terminal 200 causes audio data relating to the generated call, which is received from the tablet terminal 100, to bypass the wireless communication (BT) processor 212 or the modem 211 and to be transmitted to the hands-free accessory 300. Note that the by-pass occurs either one device of the BT processor 212 and the modem 211. Further, in a state in which the connection for voice communication has been established, the PCM audio data received from the audio gateway function unit 110 of the tablet terminal 100 bypasses the wireless communication (BT) processor 212 or the modem 211 of the audio gateway function unit 210 of the portable terminal 200, and then is transmitted to the hands-free accessory 300.

Further, the PCM audio data received from the hands-free accessory 300 bypasses the wireless communication (BT) processor 212 or the modem 211 of the audio gateway function unit 210 of the portable terminal 200, and then is transmitted to the audio gateway function unit 110 of the tablet terminal 100.

Further, while the portable terminal 200 is implementing the hands-free communication mode with the tablet terminal 100 and the hands-free accessory 300, a user may place a call connection to a particular phone number through the portable terminal 200. As described above, by adding a loopback function for bypassing of the PCM audio data to an audio gateway function unit of a portable terminal, the portable terminal may transmit audio data received by a tablet terminal to a hands-free accessory and transmit audio data received from the hands-free accessory to the tablet terminal, so that the tablet terminal can perform a voice communication through the hands-free accessory.

The present invention provides an apparatus and a method for performing a hands-free function of a portable terminal, which can implement not only a communication function of the portable terminal itself but also a communication function of a tablet terminal in communication with the portable terminal through Bluetooth wireless communication, by applying a Bluetooth hands-free profile function to the portable terminal. In addition, according to the present invention, audio data can be transmitted and received between a tablet terminal and a hands-free accessory through loopback processing of PCM audio data of a portable terminal employing a hands-free profile function, thus allowing communication between tablet terminals.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the invention has been shown and described with reference to a certain embodiment thereof, it will be understood by those skilled in the art that various changes in form and details may be made therein without departing from the spirit and scope of the invention as defined by the appended claims.

What is claimed is:

1. An apparatus for performing a hands-free function of a portable terminal, the apparatus comprising:
a hands-free function unit, in communication with an audio gateway function unit of another device, configured to implement a hands-free communication mode; and
an audio gateway function unit configured to output audio data received from said another device to the portable terminal and to transmit audio data input from the portable terminal to said another device during the hands-free communication mode.

2. The apparatus as claimed in claim 1, wherein said another device is another portable terminal including only an audio gateway function.

3. The apparatus claimed in claim 1, wherein the hands-free function unit implements the hands-free communication mode with said another device through Bluetooth wireless communication.

4. An apparatus for performing a hands-free function of a portable terminal, the apparatus comprising:
a hands-free function unit, in communication with a first device, configured to implement a hands-free communication mode; and
an audio gateway function unit, in communication with a second device, configured to implement the hands-free communication mode, wherein the audio gateway function unit allows bypassing of audio data received from the first device and transmits the audio data received from the first device to the second device, and allows bypassing of audio data received from the second device and transmits the audio data received from the second device to the first device.

5. The apparatus as claimed in claim 4, wherein the audio gateway function unit comprises a modem and a wireless communication processor, and wherein the audio data received from the first device or the audio data received from the second device bypass the modem or the wireless communication processor.

6. The apparatus as claimed in claim 5, wherein the modem or the wireless communication processor performs a loopback of the audio data, so as to cause the audio data to bypass the modem or the wireless communication processor.

7. The apparatus as claimed in claim 4, wherein the first device is a portable terminal including only an audio gateway function, and the second device is a hands-free device including only a hands-free function.

8. The apparatus as claimed in claim 4, wherein the hands-free function unit implements the hands-free communication mode with the first device through Bluetooth wireless communication, and the audio gateway function unit implements the hands-free communication mode with the second device through Bluetooth wireless communication.

9. A method of performing a hands-free function of a portable terminal, the method comprising:
switching a mode of the portable terminal into a hands-free communication mode by a hands-free function unit of the portable terminal in communication with an audio gateway function unit of another device;
when audio data is received from said another device, outputting the received audio data to the portable terminal during the hands-free communication mode; and
when audio data is input through the portable terminal, transmitting the input audio data to said another device during the hands-free communication mode.

10. The method as claimed in claim 9, wherein said another device is a portable terminal including only an audio gateway function.

11. The method as claimed in claim 9, wherein the hands-free function unit of the portable terminal implements the hands-free communication mode with said another device through Bluetooth wireless communication.

12. A method of performing a hands-free function of a portable terminal, the method comprising:
implementing a hands-free communication mode by a hands-free function unit of the portable terminal in communication with an audio gateway function unit of a first device, and implementing the hands-free communication mode by an audio gateway function unit of the portable terminal in communication with a hands-free function unit of a second device;
when audio data is received from the first device during the hands-free communication mode, causing bypassing of the audio data received from the first device and transmitting the audio data received from the first device to the second device; and
when audio data is received from the second device during the hands-free communication mode, causing bypassing of the audio data received from the second device and transmitting the audio data received from the second device to the first device.

13. The method as claimed in claim 12, wherein the bypassing of the audio data received from the first device or the bypassing of the audio data received from the second device is implemented by a modem or a wireless communication processor of the audio gateway function unit.

14. The method as claimed in claim 13, wherein the modem or the wireless communication processor performs a loopback of audio data, so as to cause the bypassing of the audio data received from the first device or the audio data received from the second device.

15. The method as claimed in claim 12, wherein the first device is a portable terminal including only an audio gateway function, and the second device is a hands-free device including only a hands-free function.

16. The method as claimed in claim 12, wherein the hands-free function unit of the portable terminal implements the hands-free communication mode with the first device through Bluetooth wireless communication, and the audio gateway function unit of the portable terminal implements the hands-free communication mode with the second device through Bluetooth wireless communication.
